(19) United States
(12) Patent Application Publication
(10) Pub. No.: US 2009/0120877 A1
(43) Pub. Date: May 14, 2009

(54) METHOD FOR DESALINATION

(75) Inventor: Richard Mark Pashley, Cook (AU)

Correspondence Address: WOODCOCK WASHBURN LLP, CIRA CENTRE, 12TH FLOOR, 2929 ARCH STREET, PHILADELPHIA, PA, 19104-2891, US

(73) Assignee: Murdoch University, Murdoch (AU)

(21) Appl. No.: 11/915,115

(22) PCT Filed: May 24, 2006
(86) PCT No.: PCT/AU2006/000694

§ 371 Date: Jul. 18, 2008

(30) Foreign Application Priority Data
May 25, 2005 (AU) 2005902657

(51) Int. Cl. B01D 61/04; B01D 19/00

(52) U.S. Cl. 210/652; 210/188

(57) ABSTRACT

The invention provides a process for producing a desalinated aqueous liquid. The process comprising passing a de-gassed aqueous liquid (115) through a reverse osmosis membrane (110). The process may additionally comprise the step of degassing an aqueous liquid (105) to produce the degassed aqueous liquid (115).

### TECHNICAL FIELD

The present invention relates to an improved method for desalination and for apparatus for performing the method.

### BACKGROUND OF THE INVENTION

Reverse osmosis (RO) as a method of commercial scale desalination, holds a large share of the international market. The market for large scale desalination is growing rapidly, fuelled by government and business alike. The UN has labelled this century “the century of ocean water desalination”. It was estimated in 1998 that RO holds approximately 40% of the global market for desalination, second only to the multistage flash (MSF) method (an evaporative technique).

Reverse osmosis is a membrane technology in which a pressure difference is applied across a water-permeable membrane in order to isolate the salt in a brine or concentrate. The pressure differences used commonly range from about 35 to 100 atm. The efficiency of the process depends critically on the water flux through the membrane. “An increase in recovery rate and permeate flux in seawater systems can improve the economics of the desalting process.” (Hussain, A. R. Desalination 165 (2004) 11-22). A recent case study suggested that a major component of a 20% decline in flux should be assumed to be due to “fouling and compaction.” (Polasek, V et al. Desalination 156 (2003) 239-247), in other words, due to the flux being blocked in some way within the membrane.

The materials from which the membranes are made is an obvious parameter in determining flux rate and performance. The earliest RO membranes, still widely in use, are made from cellulose acetate (CA). However, thin-film composites are becoming more popular. FILMTEC thin-film membranes are made up of a “thin aromatic polyamide barrier layer” in order to allow high water flux, and beneath this is a “thick micro porous polysulfone sublayer” (FILMTEC, Product Information: FILMTEC Membranes). Most recent research has focussed on optimisation via hybrid systems, namely Multi-stage Flask (MSF, an evaporative technique) and RO hybrids. These hybrids are used to improve yield and reduce running costs.

Reverse osmosis (RO) membranes are commonly produced by the interfacial precipitation of a suitable soluble polymer, usually cellulose acetate, or by the formation of a composite polyimide/polysulfone membrane. It is important that the membranes are asymmetric, where only a very thin surface layer, or barrier layer, acts as a barrier to solutes. The surfaces of these membranes are also smooth to facilitate cross flow filtration, to reduce fouling. The thin surface ‘skin’ layer, typically about 2 microns in thickness, contains nano-sized pores and is supported by a microporous or woven support, as the main body and mechanical strength of the membrane. A scanning electron micrograph of a section through a commercial cellulose acetate membrane is shown in FIG. 1.

The skin layer is the active part of the membrane and contains very fine pores of diameter in the region of 1 nm. These pores allow only water to pass through and so can be used to desalinate salt water when a sufficiently high pressure is applied to the salt solution (typically in the range 10-100 bars). It is believed that the surfaces of the pores are essentially hydrophobic, partly because the environment within the fine pores will have a much lower dielectric constant than for bulk water. For example, cellulose (tri-) acetate (CA) has almost all hydroxyl groups of cellulose replaced by acetate ester groups and so cannot efficiently hydrogen bond to water. It also has a low dielectric constant, of 3.5-4.5, compared with water at 80. Thus, these fine pores repel water and ions but water can be forced into the pores at sufficiently high pressures. Ionic salt is largely excluded and hence the membranes can be used for desalination. For sea water, applied pressures above its natural osmotic pressure (of about 25 bar) have to be used to force water into the pores from the concentrated salt solution. It should be realised that water molecules have a higher energy state in the pores, compared with bulk water.

A disadvantage with current reverse osmosis systems is the relatively low flux of desalinated water produced. This may be at least partially overcome by use of increased pressure and/or increased membrane surface area. However both of these solutions entail increased cost and may also require increased maintenance efforts.

### OBJECT OF THE INVENTION

It is the object of the present invention to substantially overcome or at least ameliorate one or more of the above disadvantages.

### SUMMARY OF THE INVENTION

In a first aspect of the invention there is provided a process for producing a desalinated aqueous liquid, said process comprising passing a degassed aqueous liquid through a reverse osmosis membrane.

The process may comprise crossflow reverse osmosis. The crossflow reverse osmosis may comprise passing the degassed aqueous liquid across a first face of the reverse membrane under a transmembrane pressure greater than the osmotic pressure of the degassed aqueous liquid. The first face may be that face adjoining a barrier layer, or skin layer, of the reverse osmosis which restricts passage of dissolved salts. The reverse osmosis membrane may be in any suitable configuration, for example flat sheet, spiral wound, hollow fibre, pleated sheet etc. Such configurations are well known in the art.

The process may be applied to any degassed aqueous liquid having a solute which is capable of being at least partially removed by reverse osmosis. The solute may be a polar solute, and may be an ionic solute. The solute may be a salt. The degassed aqueous liquid may have one such solute or may have a mixture of more than one such solute. A suitable aqueous liquid is sea-water, in which the solute is sodium chloride together with smaller amounts of other salts. It will be understood that the term “desalinated” and related terms (e.g. desalinating, desalination) in the context of the present invention refers to removal of at least a part of the solute or solutes in the aqueous liquid. The term need not describe 100% removal, and the degree of removal of the solute or solutes may depend on the nature of the solutes, the concentrations thereof, the nature of the reverse osmosis membrane, the flow rates used in the process and/or on other factors. The degree of removal, or of desalination, may commonly be greater than about 50%, or greater than about 80%, depending on the above factors.

The degassed aqueous liquid may be partially degassed. It may be for example at least 80% degassed, or at least 90 or 95% degassed.

The process may also comprise providing the degassed aqueous liquid. The providing may comprise degassing an aqueous liquid to produce the degassed aqueous liquid. The degassing is conducted prior to passing the degassed aqueous liquid through the reverse osmosis membrane. Thus the process may comprise the step of degassing the aqueous liquid prior to passing the degassed aqueous liquid through the reverse osmosis membrane. The degassed aqueous liquid may be passed to the reverse osmosis membrane following the degassing in such a manner that substantially no gas dissolves during said passing. It may be passed to the reverse osmosis membrane without contacting the degassed aqueous liquid with a gas, e.g. air. It may be passed to the reverse osmosis membrane through an enclosed conduit that is substantially impermeable to gas.

The step of degassing may comprise vacuum distilling the aqueous liquid. It may comprise membrane distilling the aqueous liquid. It may comprise passing the aqueous liquid past a porous membrane under a transmembrane pressure which is insufficient to cause the aqueous liquid to pass through the membrane. It may comprise applying a vacuum to the side of the membrane away from the face past which the aqueous liquid is passed. In this process, gas and vapour from the aqueous liquid pass through the porous membrane, and the aqueous liquid does not pass through the porous membrane. The vapour may be condensed to form a liquid distillate. The distillate may be a purified aqueous liquid. It may have a lower concentration of solutes than the aqueous liquid entering the degassing step. The distillate from the vacuum distilling may be collected and/or may be combined with the at least partially desalinated aqueous liquid. The step of vacuum distilling may comprise membrane distillation. The step of degassing may optionally comprise heating the aqueous liquid. The heating, if conducted, may be to a temperature between about 40 and about 95° C., provided that the degassing unit (i.e. a membrane in the degassing unit and/or other components of the degassing unit) can withstand the temperature without damage. The step may optionally also comprise cooling the degassed aqueous liquid, for example cooling to room temperature, or to a temperature at which the degassed aqueous liquid will not damage the reverse osmosis unit at the pressure used therein. Alternatively, the process of the invention may be conducted without heating the aqueous liquid. This may serve to reduce the energy consumption of the process. It will be understood that flowing the aqueous liquid through conduits, pipes etc. and pumping the aqueous liquid may provide minor heating effects. However the process may be conducted without conducting a process which is intended to heat the aqueous liquid.

The step of degassing may comprise removing at least 80, 90 or 95% of gases dissolved in the aqueous liquid. The process may be such that the concentration of a dissolved salt in the degassed aqueous liquid before the step of passing the degassed aqueous liquid through the reverse osmosis membrane is at least 5 times higher than the concentration of the dissolved salt in the desalinated aqueous liquid. The flux of the degassed aqueous liquid through the reverse osmosis membrane may be at least 10% higher than the flux through the reverse osmosis membrane at the same transmembrane pressure using the same aqueous liquid that has not been degassed.

The step of passing a portion of the degassed aqueous liquid through the reverse osmosis membrane may be conducted using a transmembrane pressure at least 10% greater than the osmotic pressure of the degassed aqueous liquid.

The process may comprise removing particulate matter from the aqueous liquid prior to the at least partially desalinating. The removing may comprise passing the aqueous liquid (either degassed or undegassed) through a filter capable of removing the particulate matter. The filter may comprise one or more of a depth filter, a media filter, a microporous membrane (e.g. 0.1, 0.22, 0.4 or 0.5 micron pore size microporous membrane) or some other suitable filter. The process may also comprise one or more other purification processes, e.g. settling, centrifuging, ultracentrifuging, deionising etc.

In a second aspect of the invention there is provided a water treatment apparatus comprising a degassing unit and a reverse osmosis unit, whereby, in operation, a degassed aqueous liquid passes from the degassing unit to the reverse osmosis unit in a manner such that substantially no gas dissolves in the degassed aqueous liquid during said passing.

The water treatment apparatus may comprise a liquid conduit connecting the degassing unit to the reverse osmosis unit, said liquid conduit being capable of allowing a degassed aqueous liquid to pass to the reverse osmosis unit in a manner such that substantially no gas dissolves in the degassed aqueous liquid during said passing. The degassing unit may comprise a vacuum distillation unit, for example a membrane distillation unit. The water treatment apparatus may also comprise a condenser for condensing vapour from the vacuum distillation unit to produce a distillate. The degassing unit may be capable of at removing at least 80% of dissolved gas from an aqueous liquid saturated in the gas. The water treatment apparatus may be capable of reducing the concentration of a dissolved salt in the aqueous liquid by at least 80%.

The degassing unit may comprise one or more porous membranes. The degassing unit may be divided by the membrane(s) into a vacuum portion and a liquid portion. The liquid portion may be in liquid communication with both an inlet to the degassing unit and an outlet from the degassing unit. The outlet may communicate with the liquid conduit leading to the reverse osmosis unit. The degassing unit may be fitted with a vacuum pump for applying a vacuum to the vacuum portion of the degassing unit. The degassing unit may optionally comprise a heater for heating the aqueous liquid, for example to a temperature between about 40 and about 95° C. The degassing unit may optionally also comprise a cooler for cooling the degassed aqueous liquid, for example to room temperature, following the degassing. Alternatively, the apparatus of the invention may not comprise a heater.

The reverse osmosis unit may comprise one or more reverse osmosis membranes. The reverse osmosis membrane(s) may divide the reverse osmosis unit into a feed region and a permeate region. The reverse osmosis membrane(s) may be oriented so that the skin layer of the reverse osmosis membrane(s) adjoins the feed region and the support layer of the reverse osmosis membrane(s) adjoins the permeate region. The feed region is connected to a retentate (or concentrate) outlet, and the permeate region is connected to a permeate outlet. The permeate outlet may be connected to a clean water reservoir, which may also be connected to the condenser for receiving distillate (condensate) from the degassing unit.

Typically, the water treatment apparatus of the present invention is capable of generating a flux of aqueous liquid through the reverse osmosis membrane at least 10% higher than the flux of aqueous liquid through the reverse osmosis membrane at the same transmembrane pressure using the same aqueous liquid but not using the degassing unit.

The reverse osmosis unit may comprise a pressuriser capable of applying a transmembrane pressure across the reverse osmosis membrane of at least 10% greater than the osmotic pressure of a degassed aqueous liquid produced by the degasser. The pressuriser may comprise a pump. The pressuriser may be fitted to the liquid conduit. Inlet liquid to the pressuriser may be supplied from the degassing unit, and the pressuriser may provide pressurised degassed aqueous liquid as feed to the reverse osmosis unit.

In a third aspect of the invention there is provided a method of using a water treatment apparatus to produce a desalinated aqueous liquid, said apparatus comprising a degassing unit and a reverse osmosis unit, said method comprising:
passing an aqueous liquid through the degassing unit to produce a degassed aqueous liquid;
passing the degassed aqueous liquid to the reverse osmosis unit in a manner such that substantially no gas dissolves in the degassed aqueous liquid during said passing; and
passing a portion of the degassed aqueous liquid through a reverse osmosis membrane in the reverse osmosis unit under sufficient pressure to produce the desalinated aqueous liquid.

The water treatment apparatus may be as described in the second aspect of the invention. The method may additionally comprise condensing vapour from the degassing unit to form a distillate, and combining the distillate with the desalinated aqueous liquid from the reverse osmosis unit.

The invention also provides desalinated aqueous liquid when produced by a process or a method according to the present invention.

### BRIEF DESCRIPTION OF THE DRAWINGS

A preferred embodiment of the present invention will now be described, by way of an example only, with reference to the accompanying drawings wherein:

FIG. 1 is a scanning electron micrograph (SEM) of a freeze-fractured commercial cellulose acetate reverse osmosis membrane;

FIG. 2 is a schematic diagram of vapour/gas cavitation in a narrow pore in the skin layer of a reverse osmosis membrane;

FIG. 3 is a schematic diagram of a water purification apparatus according to the invention;

FIG. 4 is a photograph of a two stage desalination unit used in the Example; and

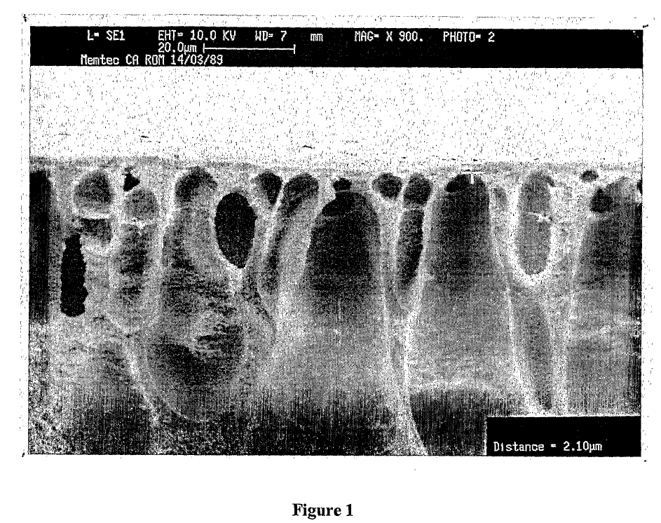

is FIG. 5 is a graph of product flow rate using normal feed water and de-gassed feed water using the desalination unit of the Example.

### DETAILED DESCRIPTION OF THE INVENTION AND PREFERRED EMBODIMENTS

The present invention provides a process for producing a desalinated aqueous liquid, said process comprising passing a degassed aqueous liquid through a reverse osmosis membrane. The method may comprise crossflow reverse osmosis or may comprise static, or dead-ended reverse osmosis.

The crossflow reverse osmosis may comprise passing the degassed aqueous liquid across the skin layer of the reverse membrane (i.e. past the surface of the membrane adjoining the skin layer) under a transmembrane pressure greater than the osmotic pressure of the degassed aqueous liquid. In this process degassed aqueous liquid passes from a feed side of the reverse osmosis membrane to a permeate side. The skin layer may be located at the feed side. The pressure on the feed side of the membrane should be greater than the pressure on the permeate side. The pressure difference between the feed side and the permeate side is termed the “transmembrane pressure”. Thus a portion of the degassed aqueous liquid then passes through the reverse osmosis membrane. Salts and/or other solutes are at least partially rejected by the membrane. In this way the permeate (i.e. that degassed aqueous liquid that passes through the membrane) is desalinated, i.e. solutes are at least partially removed therefrom. The degassed aqueous liquid that does not pass through the membrane (i.e. the retentate or concentrate) thereby has an increased concentration of the solutes. The ratio of retentate to permeate may depend on operating parameters of the method, e.g. transmembrane pressure, as well as the nature of the aqueous liquid (e.g. the concentration and nature of the solutes). The ratio may be between about 1:1 and about 100:1, or between about 1:1 and 50:1, 1:1 and 20:1, 1:1 and 10:1, 1:1 and 5:1, 1:1 and 2:1, 2:1 and 100:1, 5:1 and 100:1, 10:1 and 100:1, 20:1 and 100:1, 50:1 and 100:1, 2:1 and 20:1, 2:1 and 10:1, 5:1 and 50:1, 5:1 and 10:1, 10:1 and 50:1 or 10:1 and 20:1, e.g. about 1:1, 1.5:1, 2:1, 2.5:1, 3:1, 3.5:1, 4:1, 4.5:1, 5:1 10:1, 15:1, 20:1, 25:1, 30:1, 35:1, 40:1, 45:1, 50:1, 60:1, 70:1, 80:1, 90:1 or 100:1, or may be greater than 100:1.

The skin layer restricts passage of solutes such as dissolved salts and/or other solutes, so that water that passes through the membrane has a reduced concentration of the solutes. The solutes may be any solutes that are at least partially removed by the reverse osmosis membrane. They may for example be salts, ionic species, dissolved ions, organic molecules (charged or uncharged) or other removable species. The aqueous solution may comprise one or more salts, optionally together with one or more other solutes, and water. The aqueous solution may comprise no components that adversely affect (e.g. degrade, oxidise etc.) the reverse osmosis unit or the degassing unit. The aqueous liquid may be seawater. Species that may be dissolved in the aqueous liquid and that may be removed include carbonate, chloride, sodium, sulfate, magnesium, calcium, potassium, bicarbonate, bromide, strontium, boron, silica and fluoride. The concentration of the solutes (either individually or in total) in the aqueous liquid (either before or after degassing) may commonly be less than about 10% (w/w, w/v or mol %), or less than about 5, 2, 1, 0.5, 0.2 or 0.1%, or between about 0.1 and 10, 0.5 and 10, 1 and 10, 3 and 10, 5 and 10, 0.1 and 5, 0.1 and 2, 0.1 and 1, 0.1 and 0.5, 0.5 and 5, 1 and 5 or 2 and 4%, e.g. about 0.1, 0.2, 0.3, 0.4, 0.5, 0.6, 0.7, 0.8, 0.9, 1, 1.5, 2, 2.5, 3, 3.5, 4, 4.5, 5, 6, 7, 8, 9 or 10%. It will be understood that concentrations of greater than 10% may also be used, however the flux through the reverse osmosis membrane is generally reduced as the concentration increases for any given transmembrane pressure.

The reverse osmosis membrane may be in any suitable configuration, for example flat sheet, spiral wound, hollow fibre, pleated sheet etc. Such configurations are well known in the art. The reverse osmosis membrane may be any suitable reverse osmosis membrane. These are well known in the art. The reverse osmosis membrane may be an asymmetric membrane. The reverse osmosis membrane may be a cellulose acetate membrane. The reverse osmosis membrane may be a composite membrane. The reverse osmosis membrane may comprise a polyamide or a polyimide membrane, e.g. an aromatic polyamide or polyimide membrane. The polyamide membrane may be coupled to a support layer, e.g. a polysulfone support. The support may be microporous and/or macroporous.

As noted earlier, in the context of the present invention the term “desalinating” refers to removal of at least a part of the solute or solutes in an aqueous liquid. The degree of removal, or of desalination, achieved by the method (or achievable by the apparatus) of the invention may be greater than about 50%, or greater than about 60, 70, 80, 90, 95, 96, 97, 98 or 99%, and may for example be about 50, 55, 60, 65, 70, 75, 80, 85, 90, 95, 96, 97, 98, 99, 99.5, 99.6, 99.7, 99.8 or 99.9%. This degree of removal may refer to the total dissolved matter of the aqueous liquid or to any individual solute or group of solutes in the aqueous liquid.

The degassed aqueous liquid which is subjected to reverse osmosis in the present invention may be at least about 80% degassed, or at least about 85, 90, 95 or 99% degassed, for example about 80, 85, 90, 91, 92, 93, 94, 95, 96, 97, 98, 99, 99.5, 99.6, 99.7, 99.8, 99.9, 99.95, 99.96, 99.97, 99.98 or 99.99% degassed. The concentration of gas in the degassed aqueous liquid may be between about 0.1 and 200 micromolar, or between about 0.1 and 100, 0.1 and 50, 0.1 and 20, 0.1 and 10, 0.1 and 5, 0.1 and 2, 0.1 and 1, 0.1 and 0.5, 0.1 and 0.2, 1 and 200, 10 and 200, 50 and 200, 100 and 200, 1 and 100, 10 and 100, 1 and 20 or 10 and 50 micromolar, e.g. about 0.1, 0.2, 0.3, 0.4, 0.5, 0.6, 0.7, 0.8, 0.9, 0.1, 0.2, 0.3, 0.4, 0.5, 0.6, 0.7, 0.8, 0.9, 1, 2, 3, 4, 5, 6, 7, 8, 9, 10, 20, 30, 40, 50, 60, 70, 80, 90, 100, 120, 140, 160, 180 or 200 micromolar.

The method of the invention may also comprise the step of degassing an aqueous liquid to produce the degassed aqueous liquid prior to passing the degassed aqueous liquid through the reverse osmosis membrane. The degassed aqueous liquid may be passed to the reverse osmosis unit in such a manner that substantially no gas dissolves in the degassed aqueous liquid during said passing. The degassed aqueous liquid may be passed to the reverse osmosis unit through an enclosed conduit that is substantially impermeable to gas. In the context of the present invention, this relates to a conduit that allows sufficiently little gas to penetrate that the flux of liquid through the reverse osmosis membrane is greater than it would have been had the feed stream to the reverse osmosis membrane not been degassed. Similarly, the manner of passing the gas to the reverse osmosis unit may be such that sufficiently little gas dissolves in the degassed aqueous liquid that the flux of aqueous liquid through the reverse osmosis membrane is higher (e.g. at least about 5, 10, 15 or 20% higher) than it would have been had the aqueous liquid not been degassed. The amount of gas dissolving in the degassed aqueous liquid during said passing may be less than about 10% of the amount of the gas dissolved in the aqueous liquid when said aqueous liquid is in equilibrium with the atmosphere, or less than about 5, 2, 1, 0.5, 0.2, 0.1, 0.05 or 0.01 % of said amount of the gas. The aqueous liquid may be degassed by at least partially vacuum distilling, e.g. membrane distilling, the aqueous liquid. In an example of this process, the aqueous liquid is passed across a porous membrane under a transmembrane pressure which is insufficient to cause the aqueous liquid to pass through the membrane. The porous membrane may be microporous or nanoporous. It may be hydrophobic. It may for example be made from a polyolefin (e.g. polypropylene, polyethylene) or a fluorocarbon (e.g. polyvinylidene fluoride, polytetrafluoroethylene [Teflon]) or some other hydrophobic material (e.g. hydrophobic polymer). It may have a pore size of between about 5 and about 500 nm, or between about 5 and 200, 5 and 100, 5 and 50, 5 and 10, 10 and 500, 50 and 500, 100 and 500, 200 and 500, 10 and 100, 10 and 50, 30 and 50 or 50 and 100 nm, e.g. about 5, 10, 15, 20, 25, 30, 35, 40, 45, 50, 60, 70, 80, 90, 100, 150, 200, 250, 300, 350, 400, 450 or 500 nm. The pore size may be a maximum pore size or a mean pore size. The transmembrane pressure may be applied by applying a vacuum to the side of the membrane away from the face past which the aqueous liquid is passed. The vacuum may have an absolute pressure of less than about 100 mbar, or less than about 50, 20, 10, 5, 2, 1, 0.5, 0.2 or 0.1 mbar, for example about 0.1, 0.2, 0.3, 0.4, 0.5, 0.6, 0.7, 0.8, 0.9, 1, 2, 3, 4, 5, 6, 7, 8, 9, 10, 15, 20, 25, 30, 35, 40, 45, 50, 60, 70, 80, 90 or 100 mbar. It will be understood that the smaller the pore size of the porous membrane, the greater the transmembrane pressure may be, for a particular aqueous liquid, without causing the aqueous liquid to pass through the membrane, i.e. the lower the absolute pressure of the vacuum may be.

The step of degassing may optionally comprise heating the aqueous liquid. It is well known that the solubility of a gas in a liquid generally decreases as temperature of the liquid is increased. Thus heating may facilitate the degassing. The heating, if conducted, may be to a temperature between about 40 and about 95° C., or between about 40 and 70, 50 and 95 or 70 and 95° C., for example to about 40, 45, 50, 55, 60, 65, 70, 75, 80, 85 90 or 95° C. The heating may be conducted in conjunction with, or separately from, the vacuum distilling. Commonly heating alone (i.e. in the absence of vacuum distilling) provides only limited degassing (e.g. up to about 80%, or between about 50 and 80%). The step of degassing may optionally also comprise cooling the degassed aqueous liquid following the degassing, for example cooling to room temperature, or to a temperature at which the degassed aqueous liquid will not damage the reverse osmosis unit at the pressure used therein. The degassed aqueous liquid may be cooled to between about 10 and 30° C., or between about 10 and 20, 20 and 30 or 15 and 25° C., e.g. to about 10, 15, 20, 25 or 30° C.

The distillate from the vacuum distilling may be collected and/or may be combined with the at least partially desalinated aqueous liquid. This will be particularly beneficial if the solutes removed by the method of the invention are non-volatile or of low volatility, as in this case the step of vacuum distilling will reduce the concentration of those solutes in the distillate relative to the feed to the vacuum distilling (i.e. degassing) unit. Commonly ionic solids such as salts have low volatility. The collecting may comprise passing gases and/or vapours from the vacuum distilling to or through or past a condenser. It may comprise condensing a liquid from the gases and/or vapours. The condenser may be any suitable device for recovering aqueous liquid from the gases and/or vapours. It may comprise for example a cooler or chiller or a heat exchanger to reduce the temperature of the gases and/or vapours so that the aqueous liquid condenses.

It will be understood that other processes for degassing the aqueous liquid prior to subjecting it to reverse osmosis may also be used. These are well known to those skilled in the art. They may comprise one or more of: boiling the aqueous liquid (and then optionally cooling the degassed aqueous liquid), subjecting the aqueous liquid to one or more (e.g. 1, 2, 3 or 4) freeze-pump-thaw cycles, sparging the aqueous liquid with a gas which is of very low solubility in the aqueous liquid (e.g. helium), or other methods known in the art. The step of boiling, if conducted, may be conducted at atmospheric pressure, or below atmospheric pressure (e.g. between about 1 and about 1000 mbar, or between about 10 and 1000, 100 and 1000, 500 and 1000, 1 and 500, 1 and 200, 1 and 100, 1 and 50, 1 and 10, 10 and 500, 100 and 500 or 5 and 200 mbar, e.g. about 1, 5, 10, 25, 50, 100, 200, 300, 400, 500, 600, 700, 8000, 900 or 1000 mbar). It will be apparent that if the step of boiling is conducted at below atmospheric pressure, then the temperature of boiling will be below the normal boiling point of the aqueous liquid. The step of boiling may be conducted above atmospheric pressure. Boiling may provide a degree of degassing greater than about 90%, or greater than about 95, 96, 97, 98, 99 or 99.5%. It is preferable, although not essential, that the process for degassing be a continuous process, to facilitate continuous production of the desalinated aqueous liquid using the process of the invention.

The process of the present invention may be such that the concentration of a solute, such as a dissolved salt, in the aqueous liquid before passing the degassed aqueous liquid through the reverse osmosis membrane is at least 5 times higher than the concentration of the dissolved salt in the desalinated aqueous liquid, or at least 10, 20, 50 or 100 times higher (e.g. about 5, 10, 15, 20, 25, 30, 35, 40, 45, 50, 60, 70, 80, 90, 100, 150, 200, 150, 300, 350, 400, 450 or 500 times higher). The method of the invention may provide a flux of the degassed aqueous liquid through the reverse osmosis membrane at least 5% higher than the flux through the reverse osmosis membrane at the same transmembrane pressure using the same aqueous liquid that has not been degassed, or at least 10, 15 or 20% higher, for example about 5, 6, 7, 8, 9 10, 11, 12, 13, 14, 15, 16, 17, 18, 19, 20, 25 or 30% higher.

In order to pass a liquid through a reverse osmosis membrane, it is necessary to apply a transmembrane pressure of at least the osmotic pressure of the liquid. In general, the greater the excess of the transmembrane pressure over the osmotic pressure, the greater the flux through the reverse osmosis membrane. The transmembrane pressure in the process of the present invention maybe at least about 5, 10, 10, 15, 20, 25, 30, 35, 40, 45, 50, 60, 70, 80, 90, 100, 120, 140, 160, 180, 200, 250, 300, 350, 400, 450 or 500% greater than the osmotic pressure of the degassed aqueous liquid, for example the transmembrane pressure may be about 5, 10, 10, 15, 20, 25, 30, 35, 40, 45, 50, 60, 70, 80, 90, 100, 120, 140, 160, 180, 200, 250, 300, 350, 400, 450, 500, 600, 700, 800, 900 or 1000% greater than the osmotic pressure of the degassed aqueous liquid. Typical transmembrane pressures are about 10 to about 120 atmospheres, and may be between about 10 and 100, 10 and 80, 10 and 60, 20 and 120, 20 and 100, 20 and 50, 35 and 100, 35 and 120, 35 and 50, 50 and 120 or 50 and 100 atmospheres, e.g. about 10, 15, 20, 25, 30, 35, 40, 45, 50, 55, 60, 65, 70, 75, 80, 85, 90, 95, 100, 105, 110, 115 or 120 atmospheres, depending on the osmotic pressure of the degassed aqueous liquid, the desired flux through the membrane etc.

It may be necessary to pretreat, e.g. pH adjust, the aqueous liquid prior to the aqueous liquid passing in to the reverse osmosis unit (either before or after degassing), or it may be unnecessary to do so. Accordingly, the method may comprise such pretreating or may not comprise such pretreating. If used, the pre-treatment may be conducted without addition of chemicals (e.g. acid, base, softeners) to the feed liquid. It may be conducted before degassing or after degassing. It may for example comprise deionising the aqueous liquid. It may comprise passing the aqueous liquid through an ion exchange column. Accordingly the apparatus of the invention may optionally comprise an ion exchange column disposed so as to be capable of deionising the aqueous liquid before it passes into the reverse osmosis unit. The pH of the aqueous liquid prior to desalinating may be between about 5 and about 9, or between about 6 and 9, 7 and 9, 5 and 7, 5 and 6, 7 and 7, 7 and a8 or 6 and 8, e.g. about 5, 5.5, 6, 6.5, 7, 7.5, 8, 8.5 or 9. The pH may be such that it does not hydrolyse, dissolve or otherwise degrade the reverse osmosis membrane.

The present invention also provides a water treatment apparatus suitable for performing the method described above. The apparatus comprises a degassing unit and a reverse osmosis unit. In operation, a degassed aqueous liquid passes from the degassing unit to the reverse osmosis unit in a manner such that substantially no gas dissolves in the degassed aqueous liquid during said passing. The passing may be through a conduit which is substantially impermeable to gas.

The reverse osmosis unit comprises a reverse osmosis membrane housed in a housing. The housing may be constructed from a material that is capable of withstanding the pressure applied to the reverse osmosis membrane (i.e. the transmembrane pressure). It may for example be made of stainless steel or other suitable metal. It may be constructed from a non-contaminating material. The reverse osmosis membrane may have an asymmetric structure. It may comprise a thin surface layer (skin layer or barrier layer) which may act as a partial or complete barrier to solutes. The thin surface layer may be about 2 microns in thickness, or may be between about 1 and about 5 microns thick or between about 1 and 3, 1 and 2, 2 and 5, 3 and 5 or 2 and 4 microns thick, e.g. about 1, 1.5, 2, 2.5, 3, 3.5, 4, 4.5 or 5 microns thick. It may contain nano-sized pores, which may be between about 0.5 and 10 nm mean diameter, or between about 0.5 and 5, 0.5 and 2, 0.5 and 1, 1 and 10, 2 and 10, 5 and 10 or 1 and 5 nm mean diameter (e.g. about 0.5, 0.6, 0.7, 0.8, 0.9, 1, 1.1, 1.2, 1.3, 1.4, 1.5, 2, 2.5, 3, 3.5, 4, 4.5 or 5 nm). The thin surface layer may be supported by a coarser porous support layer. The support may be microporous. It may have graded porosity. It may be a woven support. It may be integral with the thin surface layer or may be separate from and attached to the thin surface layer. The support layer may be the same material as the thin surface layer or may be a different material. The support layer may provide mechanical strength for the reverse osmosis membrane.

The water treatment apparatus may comprise a condenser for collecting the distillate from the vacuum distillation unit. The condenser may be capable of removing at least 50% of the vapour (e.g. the water vapour) in the gas/vapour from the distillation unit to provide a liquid distillate. It may be capable of removing at least 60, 70, 80, 90, 95 or 99% of the vapour (e.g. about 50, 55, 60, 65, 70, 75, 80, 85, 90, 95, 96, 97, 98 or 99% of the vapour) to provide the liquid distillate. The liquid distillate may be combined with the permeate from the reverse osmosis unit to provide a final reservoir of desalinated or purified water. The liquid distillate, and independently the final reservoir of desalinated or purified water, may have a concentration of a solute, such as a dissolved salt, at least about 10 times lower than the concentration of the dissolved salt in the aqueous liquid before desalinating, or at least about 20, 50 or 100 times lower (e.g. about 10, 15, 20, 25, 30, 35, 40, 45, 50, 60, 70, 80, 90, 100, 150, 200, 150, 300, 350, 400, 450 or 500 times lower. It should be understood that the step of vacuum distilling the aqueous liquid (thereby degassing it) may increase the concentration of one or more solute in the aqueous liquid, since some water may be removed from the aqueous liquid during that step without removing the solute(s). The increase in concentration will depend on the proportion of water removed during that step from the aqueous liquid, and consequently will depend on the operating conditions (vacuum, temperature, flow rate, residence time, configuration etc.) of the vacuum distillation unit. The increase may be between about 0.1 and about 50% or between about 0.1 and 20, 0.1 and 10, 0.1 and 5, 0.1 and 2, 0.1 and 1, 0.5 and 50, 0.5 and 20, 0.5 and 10, 1 and 50, 1 and 10, 5 and 10, 5 and 50, 10 and 50, 20 and 50, 10 and 30, 0.5 and 5, 0.5 and 2 or 1 and 5%, e.g. about 0.1, 0.2, 0.3, 0.4, 0.5, 0.6, 0.7, 0.8, 0.9, 1, 1.5, 2, 2.5, 3, 3.5, 4, 4.5, 5, 6, 7, 8, 9, 10, 15, 20, 25, 30, 35, 40, 45 or 50%.

The degassing unit may be capable of at removing at least about 80% of dissolved gas from an aqueous liquid saturated in the gas, or at least about 85, 90, 95 or 99%, for example about 80, 85, 90, 91, 92, 93, 94, 95, 96, 97, 98, 99, 99.5 or 99.9% of the dissolved gas.

The reverse osmosis unit may comprise a pressuriser capable of applying a desired transmembrane pressure across the reverse osmosis membrane. The pressuriser may comprise a pump (e.g. a positive displacement pump) capable of providing the required pressure. The pressuriser may comprise a constrictor for constricting a conduit connected to the retentate outlet in order to adjust the pressure of the feed stream in the reverse osmosis unit.

The apparatus of the present invention may be suitably combined with one or more other purification modules. Suitable modules include a distillation apparatus, a membrane microfilter, a packed bed filter, a depth filter, a spiral wound filter, an ultrafilter, a deioniser, an ion exchanger, a centrifuge, an ultracentrifuge, a settler and other modules capable of removing dissolved, suspended, emulsified or dispersed materials from an aqueous liquid. One or more of the modules may be capable of at least partially removing macromolecules (e.g. dissolved materials with a molecular weight greater than for example about 2000, 5000 or 10000). One or more of the modules may be capable of at least partially removing suspended solids, e.g. solids with a particle size above about 0.1 microns, or above 0.2, 0.5 or 1 micron. The locations of these modules will be readily apparent to those skilled in the art. For example a microfilter may be used as a pre-treatment before the degassing unit, or between the degassing unit and the reverse osmosis unit, for removing suspended solids from the aqueous liquid or the degassed aqueous liquid, in order to reduce fouling of the degassing unit or the reverse osmosis unit or both. A deioniser may be used as a pre-treatment, for example before the reverse osmosis unit, or as a polishing filter after the reverse osmosis unit. The process of the invention may additionally comprise one or more intermittent cleaning steps to reverse or prevent fouling of any portion of the apparatus. These may comprise chemical and/or physical cleaning steps.

The rate of production of desalinated aqueous liquid from the apparatus of the invention depends on the size of the water treatment apparatus, as well as on the design of the apparatus and the nature of the aqueous liquid. Thus the apparatus may be scaled up or down to provide desalinated aqueous liquid at a desired rate. The output rate may be for example between about 0.1 and about 1000 litres per hour, or may be greater than 1000 litres per hour (e.g. 2, 3, 4, 5, 10, 50 or 100 megalitres/hour). It may be between about 0.1 and 100, 0.1 and 10, 0.1 and 1, 1 and 1000, 10 and 1000, 100 and 1000, 500 and 1000, 1 and 100, 10 and 100, 1 and 10, 50 and 500 or 100 and 500 litres per hour, for example about 0.1, 0.2, 0.3, 0.4, 0.5, 0.6, 0.7, 0.8, 0.9, 1, 2, 3, 4, 5, 6, 7, 8, 9, 10, 15, 20, 25, 30, 350, 40, 45, 50, 60, 70, 80, 90, 100, 150, 200, 250, 300, 350, 400, 450, 500, 600, 700, 800, 900 or 1000 litres per hour. It will be understood that scaling to any particular production rate is a matter of routine engineering. The scaling may for example require adjustment in the size of the pipes, conduits and tubes, in the capacity of the pumps (i.e. the pressuriser for the reverse osmosis unit and the vacuum pump for the degassing unit) and the membrane surface area of the membranes in the degassing unit and the reverse osmosis unit, as well as other parameters.

It is necessary to match the capacities of components of the apparatus to each other. It will be clear that the flow of degassed aqueous liquid that exits the degassing unit should match the flow of feed to the reverse osmosis unit. Thus the throughput capacity of the degassing unit is preferably matched to the capacity of the reverse osmosis unit (although it is possible to provide an overflow valve to divert excess production of degassed aqueous liquid). Also the vacuum pump which provides vacuum for the degassing unit should be sized appropriately to provide the level of vacuum required for the volume of the vacuum portion of the degassing unit. The pressuriser should be sized appropriately to provide the desired transmembrane pressure within the reverse osmosis unit.

The basic model of reverse osmosis is reasonably well understood but the precise mechanisms involved in determining its water transport selectivity are still not fully understood. For example, the flux through these membranes is lower than expected and currently there is still no generally accepted explanation for this. The pores in the skin layer of a reverse osmosis membrane are typically about 1 nm wide and 2 microns long and the water present in these pores experience a high pressure gradient through the skin layer. The application of comparable pressures to bulk water causes cavitation when the pressure is released. The degree of cavitation depends on a range of factors including pressure differentials, equilibrium, the presence or absence of dissolved gases and the nature of the walls of a vessel in which the water is located. In a related field, it has been reported that cavitation in plants limits the uptake of water through its channels. The pore walls of typical reverse osmosis membranes, such as cellulose acetate, are relatively hydrophobic.

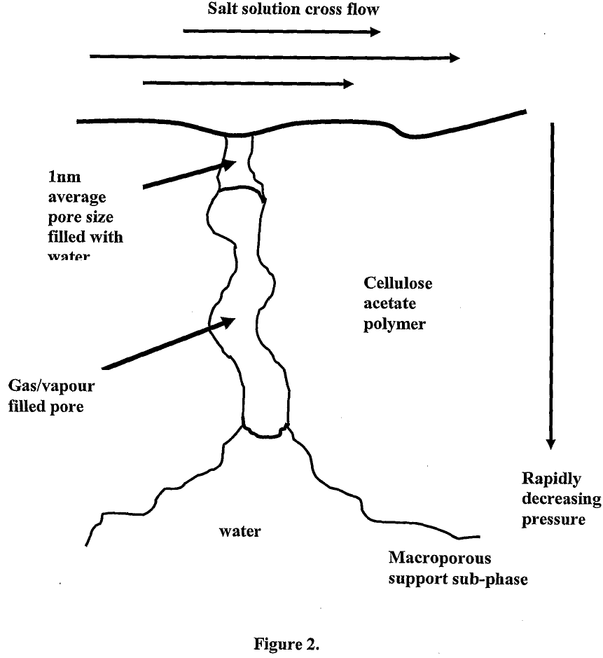

The inventors theorise that it is likely that some degree of cavitation will occur in the fine pores in the skin layer of a reverse osmosis membrane when operating under high pressure differentials. Further, the small diameter of these pores suggests that the cavities formed may fill significant sections of the pores for a certain amount of time and so reduce flow rate through the membrane. This situation is illustrated schematically in FIG. 2. This may explain the lower flow rates observed through current reverse osmosis membranes. The concentrations of dissolved gases in water which is equilibrated with the atmosphere are sufficient for the dissolved gases to be potential causes of nucleation. For example, the number of water molecules required to fill a 1 nm diameter, 2 micron pore is about 50,000 and there is about 1 dissolved gas molecule per 50,000 water molecules in bulk water, under normal atmospheric conditions. It therefore seems reasonable to expect that these gas molecules, passing through the pores, under a highly differential pressure, could nucleate water cavitation, especially given the high energy state of these water molecules.

The commercial availability of large quantities of highly de-gassed water has only become possible since the development of hollow fibre, hydrophobic porous membranes in 1994. In order to use these membranes for degassing, normal gassed water or salt solution is passed through the hollow centre of an array of hydrophobic fibres, which contain many very fine pores (of about 0.01 microns) and the outside of the fibres is placed under vacuum. Because of the Laplace pressure generated in the fine, hydrophobic pores, the solution cannot flow through the pores but water vapour and dissolved gases can. These vapours and gases are carried away by the vacuum system. These membranes are now used industrially to produce oxygen free water down to ppb levels. This water may be used, for example as cooling water, because of its anti-rust properties. Water de-gassed to this extent corresponds to a de-gassing level of about 99.98%. Atmospheric equilibrated water commonly has a dissolved gas concentration of about 1 mM. This level of de-gassing has a strong influence on preventing cavitation in water.

In addition to producing de-gassed water or salt solution, hollow fibre membranes also produce desalinated water, since the water vapour passing through the hollow fibre pores is pure and can easily be collected. This process is called “vacuum distillation”, or “membrane distillation”.

A water-permeated porous membrane, under a large hydrostatic pressure differential, is likely to create opportunities for vapour and gas cavitation, which may restrict water flow through the pores of the membrane. The formation of cavities within the pores may be facilitated by the presence of dissolved gases in water. The inventors therefore postulate that removal of these gases may reduce or prevent cavitation and may therefore increase flow rate through porous membranes used to purify water. Reverse osmosis (RO) membranes operate under high pressure differentials and may therefore be very susceptible to cavitation reduced flow. It is well established that RO membranes have a lower water flux than expected however the reasons for this have yet to be identified in the open literature.

The inventors have surprisingly found that at least partial removal of dissolved gases (i.e. degassing) from an aqueous liquid used as a feed stream for a reverse osmosis membrane can substantially increase the flux through the membrane for a given transmembrane pressure. For example, a water treatment apparatus can efficiently produce drinking water from sea water or salt water by a process of desalination, using degassed feed water. In an embodiment of the invention, a first stage (a degassing unit) of the water treatment apparatus comprises a polypropylene or Teflon hollow fibre filter to de-gas the feed water. This unit has two functions: it produces purified water by a vacuum distillation process and also de-gases the feed water. This de-gassed feed water is then used in a reverse osmosis unit to produce purified water at a higher flow rate than for conventional systems using the same transmembrane pressure.

Experimental evidence is provided herein, obtained with a commercial RO unit, demonstrating an average increase in product flow-rate of about 20% on de-gassing the feed water, consistent with the proposed cavitation model described above. A combination of a hollow fibre de-gassing filter (e.g. using a hydrophobic membrane) and a reverse osmosis unit can be used as a very efficient and novel method for producing desalinated water. For example sea water may be converted to potable water in large quantities using a water treatment apparatus as described herein.

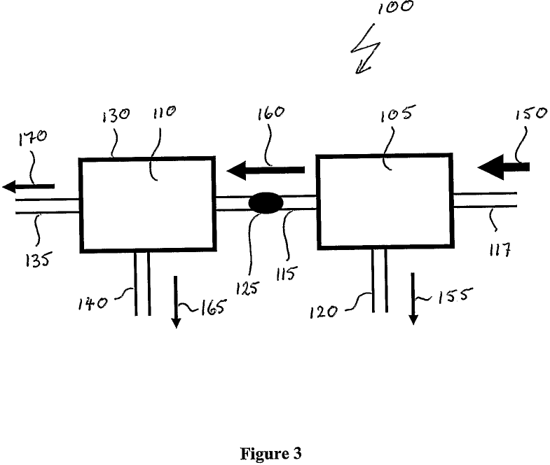

A flow diagram illustrating an example of a water purification apparatus as described herein is shown in FIG. 3. It is important that the pumping method does not allow atmospheric gases to re-equilibrate with the salt solution delivered to the reverse osmosis unit. With reference to FIG. 3, apparatus 100 comprises degassing unit 105 and reverse osmosis unit 110. Units 105 and 10 are connected by liquid conduit 115. Liquid conduit 115 is capable of allowing at least partially degassed liquid from degassing unit 105 to pass to reverse osmosis unit 110 without dissolving substantial quantities of a gas during said passing. Degassing unit 105 comprises a vacuum distillation unit, in particular a hollow fibre membrane distillation unit. Degassing unit 105 is divided by the hollow fibres of degassing unit 105 into a vacuum portion and a liquid portion. The liquid portion is in liquid communication with both inlet 117 and conduit 115, and comprises the lumens (hollow cores) of the hollow fibres. Unit 105 is fitted with a vacuum pump (not shown) for applying a vacuum to the vacuum portion of unit 105, which adjoins the outsides of the hollow fibres. The hollow fibres are porous. The pore size of the hollow fibres is sufficiently small that surface tension of the aqueous feed to unit 105 prevents the aqueous feed from passing through the pores, but is sufficiently large to permit water vapour to pass therethrough. Unit 105 is fitted with inlet 117 for admitting an aqueous feed liquid to unit 105, and thereby to apparatus 100. Inlet 117 may optionally be fitted with a microfilter (not shown), e.g. a 0.2 micron pore size membrane filter, for removing particulate matter from the feed liquid. Gases and vapours exit unit 105 through vapour outlet 120. Outlet 120 may be connected to a condenser (not shown) which can condense purified water from the vapour and gas which passes through outlet 120. Conduit 115 is fitted with pump 125, which is capable of passing degassed liquid from unit 105 through conduit 115 to reverse osmosis unit 110 under pressure sufficient for the operation of unit 110. Unit 110 comprises a reverse osmosis membrane (not shown) housed in housing 130. The reverse osmosis membrane may be a hollow fibre membrane, or a pleated sheet membrane, or may have some other configuration, The reverse osmosis membrane divides unit 110 into a feed region and a permeate region. The skin layer of the reverse osmosis membrane adjoins the feed region and the support layer of the reverse osmosis membrane adjoins the permeate region. The feed region is connected to retentate outlet 135, and the permeate region is connected to permeate outlet 140. Permeate outlet 140 may be connected to a clean water reservoir (not shown), which may also be connected to the condenser for receiving condensate from degassing unit 105.

In operation, water to be desalinated enters apparatus 100 through inlet 117 (in the direction of arrow 150), and passes through the lumens of hollow fibre membranes in degassing unit 105. A vacuum pump applies a vacuum to the outsides of the hollow fibres, thereby removing dissolved gases in the water and vapourising a portion of the water. The vapourised portion is passed out of unit 105 through vapour outlet 120 (in the direction of arrow 155) and purified water is condensed from the vapourised portion by the condenser. The unvapourised (i.e. liquid) portion of the water is passed through conduit 115 to reverse osmosis unit 110 by pump 125 (in the direction of arrow 160). Pump 125 pressurises the water in the feed region of unit 110 to the desired operating pressure. This causes water to pass through the reverse osmosis membrane of unit 110 to the permeate region, but the membrane restricts passage of dissolved salts and certain other solutes. The resulting desalinated water (permeate) passes out of unit 110 through permeate outlet 140 (in the direction of arrow 165) to the clean water reservoir. A portion of the degassed feed water to unit 110, containing solutes such as salts which have been rejected (i.e. not passed) by the reverse osmosis membrane, exits unit 110 through retentate outlet 135 (in the direction of arrow 170). Retentate outlet 135 may optionally be fitted with a constrictor, for constricting a portion of outlet 135 in order to control the pressure in the feed region of unit 110. In operation, therefore, the pressure in the feed region of unit 110 may be controlled or adjusted by controlling or adjusting pump 125 and/or the constrictor (not shown). Purified water from the condenser may be combined with permeate from unit 110 in a clean water reservoir (not shown).

Advantages of the present process over prior art methods include that (a) the wasted de-gassed salt solution in the vacuum distillation process is used as the feed for the reverse osmosis unit and (b) the efficiency of the reverse osmosis unit is enhanced by the removal of dissolved gases, allowing higher flow rates at the same or lower operating pressures (transmembrane pressures). The degree of de-gassing produced by the hollow fibre unit is related to its operating flow rate. The level of de-gassing of the aqueous solution may therefore be varied to produce optimum flow in the reverse osmosis unit.

### EXAMPLE

### Method/Equipment

A Membrana Minimodule, 1.7×5.5 Teflon hollow-fibre degassing cartridge (Membrana, Charlotte, N.C.) was used to treat feed water supplied to a Katadyn Powersurvivor 40E reverse osmosis desalinator (McIntyre Marine, Coomera, Queensland). Dissolved oxygen levels were used to monitor de-gassing using an InPro 6900 dissolved oxygen electrode system, supplied by Mettler-Toledo Limited, Melbourne, Australia. This system had high accuracy (˜1%) and detection limit down to 1 ppb, and could measure dissolved oxygen levels in water, air and liquid solvents.

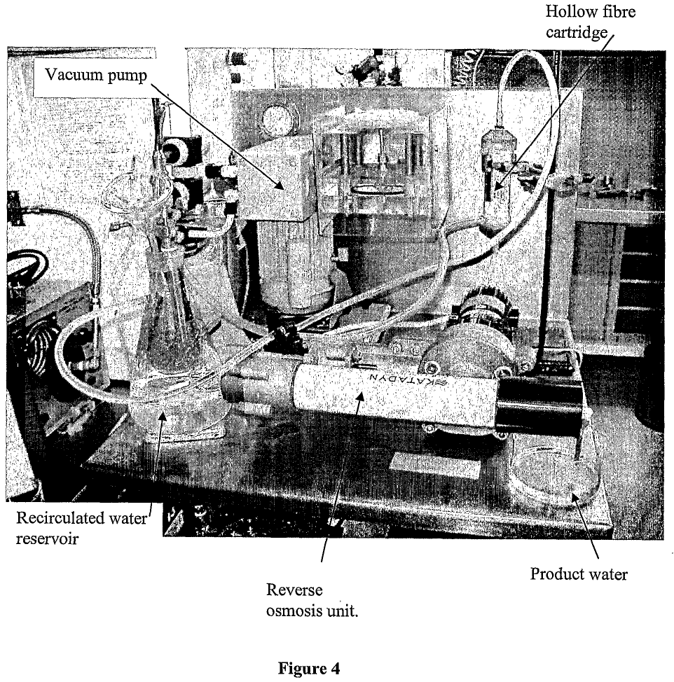

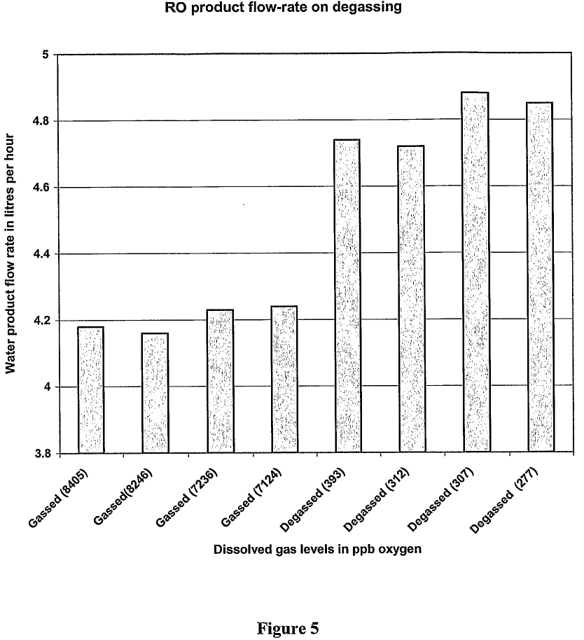

The refuse water from the desalinator was fed into a flask and the same flask was also used to supply the feed water to the hollow-fibre cartridge. See the photograph of the apparatus in FIG. 4. This allowed the water to be recirculated, for extended running times without a continuous supply of water, while recirculation through the hollow fibre cartridge allowed higher degrees of degassing to be achieved. The conductivity of the recirculated solution was used to monitor the water quality. A dissolved oxygen probe was also used to monitor the degree of degassing of the water. The desalinated product (permeate) water was collected and returned to the recirculated water reservoir, in order to keep the composition of the feed water constant (see FIG. 4).

The flow rate of the product water was recorded by measuring the time required to produce each 50 ml of product water. The flow rate was initially recorded for pure distilled water. The flow rate was recorded first for water with atmospheric equilibrated levels of dissolved gas. After several repeat experiments, a vacuum was applied to the hollow-fibre cartridge, and the water was recirculated for about 1 hr to achieve a degree of degassing greater than 95%. Then, once again, several repeat measurements were made of the product rate, with degassed water as feed. The vacuum was again removed and the water was allowed to re-equilibrate with atmospheric gases. After re-gassing, the flow rate was measured again, repeatedly, to ensure consistency with the initial values.

### Summary of the Results

A consistently higher flow rate was achieved when the feed water was degassed, compared with feed water which was equilibrated with atmospheric levels of gas. 50 ml of treated water was delivered in an average of 42.8 seconds (i.e. a flow rate of about 4.2 litres/hour) when the feed water was fed at an average dissolved oxygen level of 7752 ppb, which represents atmospherically equilibrated levels of dissolved gas. By comparison, water delivered with an average dissolved oxygen level of 321 ppb, representing water with about 96% of dissolved gas removed, was produced at an average rate of 37.5 seconds per 50 ml (i.e. a flow rate of about 4.8 litres/hour).

The results obtained for a series of gassed, de-gassed and re-gassed experiments using this equipment are given in FIG. 5. In all studies a clearly enhanced flow-rate was observed for the de-gassed feed water. The results summarized in FIG. 5 also indicate that, even within the ‘gassed’ and ‘de-gassed’ categories there is a correlation between the dissolved oxygen level and product flow rate. This suggests that higher de-gassing levels will further improve the product flow rate. FIG. 5 shows the data in terms of flow rates, and demonstrates that the dissolved gas level in the gassed and de-gassed runs also slightly affects the flow-rate.

1. A process for producing a desalinated aqueous liquid, said process comprising passing a degassed aqueous liquid through a reverse osmosis membrane.

2. The method of claim 1 comprising crossflow reverse osmosis.

3. The method of claim 1 additionally comprising the step of degassing an aqueous liquid to produce the degassed aqueous liquid.

4. The method of claim 3 wherein the degassed aqueous liquid is passed to the reverse osmosis membrane following the step of degassing in a manner such that substantially no gas dissolves in the degassed aqueous liquid during said passing.

5. The method of claim 3 wherein the step of degassing comprises vacuum distilling the aqueous liquid.

6. The method of claim 5 wherein distillate from the vacuum distilling is collected.

7. The method of claim 5 wherein distillate from the vacuum distilling is combined with the desalinated aqueous liquid.

8. The method of claim 5 wherein the vacuum distilling comprises a membrane distillation.

9. The method of claim 3 wherein the step of degassing comprises removing at least 80% of gases dissolved in the aqueous liquid.

10. The method of claim 1 wherein the concentration of a dissolved salt in the degassed aqueous liquid before said passing is at least 5 times higher than the concentration of the dissolved salt in the desalinated aqueous liquid.

11. The method of claim 1 wherein the flux of the degassed aqueous liquid through the reverse osmosis membrane is at least 10% higher than the flux through the reverse osmosis membrane at the same transmembrane pressure using the same aqueous liquid that has not been degassed.

12. The method of claim 1 wherein the step of passing a portion of the degassed aqueous liquid through the reverse osmosis membrane is conducted using a transmembrane pressure at least 10% greater than the osmotic pressure of the degassed aqueous liquid.

13. A water treatment apparatus comprising a degassing unit and a reverse osmosis unit, whereby, in operation, a degassed aqueous liquid passes from the degassing unit to the reverse osmosis unit in a manner such that substantially no gas dissolves in the degassed aqueous liquid during said passing.

14. The water treatment apparatus of claim 13 comprising a liquid conduit connecting the degassing unit to the reverse osmosis, said liquid conduit being capable of allowing a degassed aqueous liquid to pass to the reverse osmosis unit in a manner such that substantially no gas dissolves in the degassed aqueous liquid during said passing.

15. The water treatment apparatus of claim 13 wherein the degassing unit comprises a vacuum distillation unit.

16. The water treatment apparatus of claim 15 comprising a condenser for condensing vapour from the vacuum distillation unit to produce a distillate.

17. The water treatment apparatus of claim 15 wherein the vacuum distillation unit comprises a membrane distillation unit.

18. The water treatment apparatus of claim 13 wherein the degassing unit is capable of removing at least 80% of dissolved gas from an aqueous liquid saturated in the gas.

20. The water treatment apparatus of claim 13, said apparatus being capable of reducing the concentration of a dissolved salt in the aqueous liquid by at least 80%.

21. The water treatment apparatus of claim 13, said apparatus being capable of generating a flux of aqueous liquid through the reverse osmosis membrane at least 10% higher than the flux of aqueous liquid through the reverse osmosis membrane at the same transmembrane pressure using the same aqueous liquid but not using the degasser.

22. The water treatment apparatus of claim 13 wherein the reverse osmosis unit comprises a pressuriser capable of applying a transmembrane pressure across the reverse osmosis membrane of at least 10% greater than the osmotic pressure of a degassed aqueous liquid produced by the degasser.

23. A method of using a water treatment apparatus to produce a desalinated aqueous liquid, said apparatus comprising a degassing unit and a reverse osmosis unit, said method comprising:
passing an aqueous liquid through the degassing unit to produce a degassed aqueous liquid;
passing the degassed aqueous liquid to the reverse osmosis unit in a manner such that substantially no gas dissolves in the degassed aqueous liquid during said passing; and
passing a portion of the degassed aqueous liquid through a reverse osmosis membrane in the reverse osmosis unit under sufficient pressure to produce the desalinated aqueous liquid.

24. The method of claim 23 additionally comprising condensing vapour from the degassing unit to form a distillate, and combining the distillate with the desalinated aqueous liquid from the reverse osmosis unit.

25. A desalinated aqueous liquid when produced by a process comprising passing a degassed aqueous liquid through a reverse osmosis membrane.
